(19) United States
(12) Patent Application Publication
(10) Pub. No.: US 2004/0150189 A1
(43) Pub. Date: Aug. 5, 2004

(54) Mountable and storable ball mount system

(76) Inventor: Gilbert Deanda, Tucson, AZ (US)

Correspondence Address: Steven Thrasher, 391 Sandhill Dr., Richardson, TX, 75080, US

(21) Appl. No.: 10/356,281

(22) Filed: Jan. 31, 2003

(51) Int. Cl. B60D 1/00

(52) U.S. Cl. 280/491.1

(57) ABSTRACT

The invention is, in one embodiment, a ball mount storage device adapted to removeably attach to a vehicle frame. The device includes a frame-mounting portion that is adapted to attach to a vehicle frame. The frame-mounting portion includes a ball mount receptacle. In addition, the device may includes as ball mount that is adapted to coupled to the ball mount receptacle.

### TECHNICAL FIELD

Generally, the invention relates to ball mounts that pull trailers and other equipment that attach to a vehicle hitch, and more particularly, the invention relates to storage devices for such ball mounts.

### STATEMENT OF A PROBLEM ADDRESSED BY THIS INVENTION

Ball mounts that attach to automotive hitches (hitches) provide users the ability to use their vehicle to pull trailers upon which one may mount a boat, bikes, wave runners or other things. Typically, hitches are permanently mounted directly to a vehicle, such as a car, SUV, or truck, for example. This allows a user to have continuous access to the hitch. To provide hitch functionality to these vehicles, a removable ball mount is provided that is attachable to a vehicle hitch, called a receiver hitch. Since ball-mounts are often unsightly, and frequently cause problems as dangerous vehicle extensions that are not seeable by a driver, receiver hitches provide the advantage of allowing a user to remove the ball-mount from the hitch.

Unfortunately, the use of removable ball mounts is not without problems. For example, ball mounts typically mount directly into the hitch portion of a vehicle frame. However, these ball mounts, when removed, must either take space within a vehicle cab, or they are stored externally and are subject to being stolen.

In addition, these ball mounts can cause problems with vehicle clearance, especially in off-road conditions. Furthermore, in the event of an automobile accident, a ball mount can become a missile and endanger those persons who are nearby.

Accordingly, to overcome these and other disadvantages associated with existing ball mounts, it would be advantageous to provide a safe, easily installed, conveniently available, and difficult to steal ball mount that attaches to a vehicle hitch. The present invention provides such an apparatus.

### SELECTED OVERVIEW OF SELECTED EMBODIMENTS

The invention provides technical advantage as a ball mount storage device that is adapted to removeably attach to a vehicle frame. In one embodiment, the ball mount storage device includes a frame-mounting portion. The frame-mounting portion is adapted to attach to a vehicle frame, and also attaches to a ball mount via a ball mount receptacle. In an alternative embodiment, the frame-mounting portion includes a frame mounting plate that is coupled between a ball mount platform and an anchor. Accordingly, the invention provides a ball mount storage device that is easy to install, difficult to steal, and which also makes it difficult to steal a ball mount stored therein. Furthermore, in one embodiment, the ball mount storage device accommodates a variety of ball mounts.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the following is an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows one embodiment of a ball mount storage device;

FIG. 2 illustrates a ball mount for use with the ball mount storage device of FIG. 1;

FIG. 3 provides an anchor for use with the ball mount storage device of FIG. 1;

FIG. 4 shows a ball mount platform for use with the ball mount storage device of FIG. 1;

FIG. 5 illustrates a mounting plate for use with the ball mount storage device of FIG. 1;

FIG. 6 is a cut-view of the ball mount storage device of FIG. 1, the cut taken along cut line A-A of FIG. 1; and

FIG. 7 shows the device wherein the arm is in the second position, and the anchor pin, which is attached to the arm, is visible.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section.

Description of the Figures

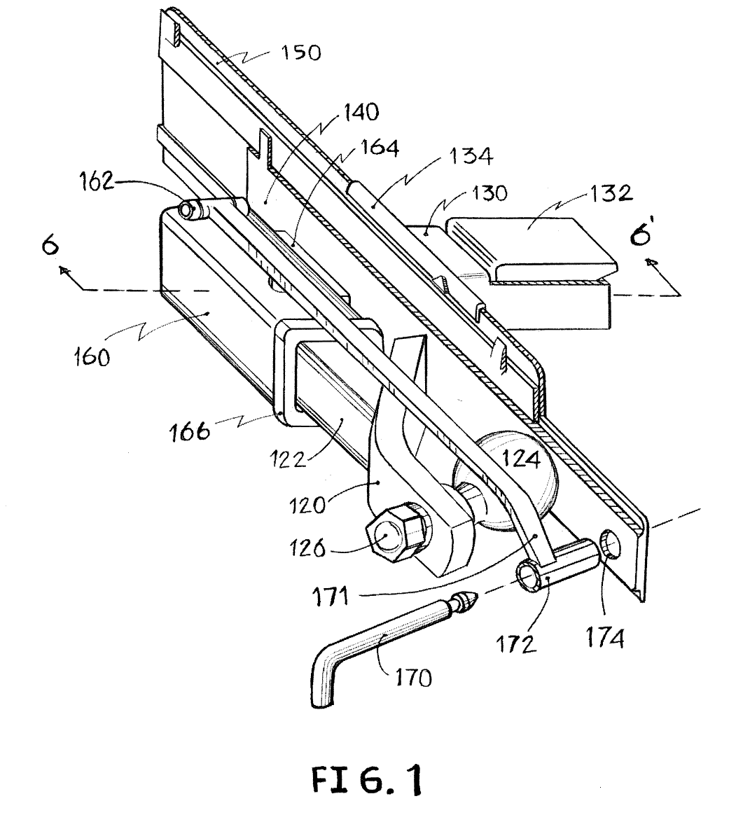

The features and benefits of the invention can be better understood by reference to the figures. FIG. 1 shows one embodiment of a ball mount storage device 100. The ball mount storage device (the device) 100 illustrated in FIG. 1 shows the device 100 as a single unit. The components that make up the device 100 will be discussed in more detail below. In FIG. 1, one may see that the device 100 includes a ball mount 112 which includes a mount base 122, mountable at a mounting lip 120, and a ball 124 that is secured to the mounting lip 120 via a ball mount nut 126.

A ball mount receptacle 160 secures the mount base 122 within, and provides a receptacle lip 166 to reinforce the ball mount receptacle 160. This global pin 162 is coupled to the ball mount receptacle, and maintain a handle 171 that is pivotally coupled to this global pin 162. A handle cylinder 172 is provided at the free end of the handle 171. The handle cylinder 172 allows a peg lock 170 to pass through the handle cylinder 172 and then through a peg lock hole 174 so that the handle 171 can be secured in a fixed position. The fixed position (shown in FIG. 1) may be secured by coupling a lock (not shown) to the peg lock 170. A pedestal 164 couples the ball mount receptacle 160 to a ball mount platform 140 the ball mount platform 130 is allowed to slide along tracks (discussed later) of a mounting plate 150.

The mounting plate 150 secures to a vehicle frame via an anchor 128. The anchor 128 is rigidly coupled to a slide rail 134, preferably via welding, riveting, bending or other means, which are well known in the art of attaching metal pieces together. The anchor 128 generally includes a flange member 130 which is the portion of the anchor that is coupled to the slide rail 134, and a wedge 132 which may be inserted into a vehicle frame and then repositioned relative to the flange 130 in a manner that secures the anchor 128 in the vehicle frame, the manner of which is apparent to those of ordinary skill in the art upon reading the present description.

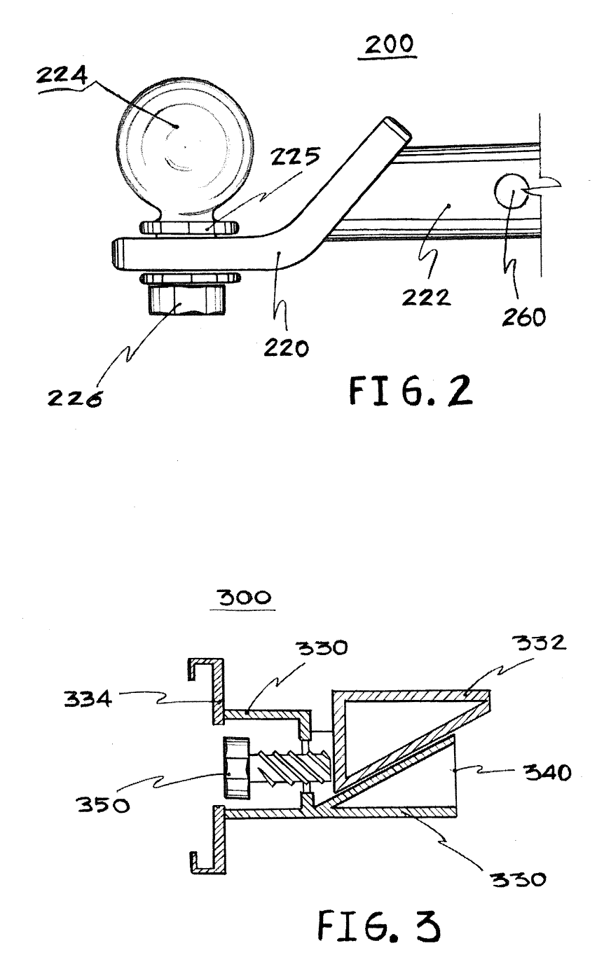

Better understanding of the device 100 may be obtained by examining the components (or parts) that comprise the device 100. Accordingly, FIG. 2 illustrates a ball mount 200 for use with the ball mount storage device 100 of FIG. 1. The ball mount 200 is generally comprised of a mount base 222 that is rigidly coupled to amounting lip 220 via welding, forging, or other rigid coupling technique as know in the art. As shown in FIGS. 1 and 2, the mount base 222 is a generally rectangular piece, preferably made of a metal, and is adapted to both fit within the ball mount receptacle 160 as well as within a vehicle frame. In addition, the mount base 222 as a mount base hole 260 which aligns with a hole in the ball mount receptacle 160 so that a portion of the handle 171 (discussed below) may secure the ball mount 200 within the ball mount receptacle 160.

The mounting lip provides a means for coupling a ball 224 to the mount base 222. As illustrated in FIG. 2, the mounting lip 220 is preferably a semi-arch shaped structure, and is preferably made of a metal. Of course, other materials may be used and other shapes may be employed to create a mounting lip 220. For example the mounting lip 220 may be comprised of two straight segments that are connected at an angle. The ball 224 is mountable to the mounting lip 220 in any manner well known in the art. For example, the ball 224 of FIG. 2 is shown mounted into the mounting lip 220 through a hole 227 in the mounting lip 220 by using a hitch ball nut 226, which threadably couples the hitch ball nut 226 to the ball 224. The ball 224 may sit flush with the mounting lip 220 or may elevate some predetermined distance above the mounting lip 220 through the use of a hitch ball platform portion 225, which may be a part of the ball 224, or may be an independent piece, operating much as a washer. Of course, as previously stated other method of coupling a ball 224 to a mount base 222 are anticipated, and will be readily apparent to those of ordinary skill in the art upon the reading of this disclosure.

Many means for securing a fitting within an existing type or frame portion are known in the art. FIG. 3 illustrates one alternative for securing an item into a frame member. Accordingly, FIG. 3 provides an anchor 300 for use with the ball mount storage device 100 of FIG. 1. In general, the anchor 300 has a flange 330 that is adapted to fit within of a portion of a vehicle frame. The flange 330 includes a platform-mounting portion 335, which is typically rectangular in shape, but may take alternative shapes to match the vehicle frame to which the device 100 is to be attached. The flange 330 also includes an inclined plane portion 340.

While the exterior of the flange 330 continues to appear as a rectangle, the inclined plane portion of the 330 is inclined within the interior of the flange 330. Upon the inclined plane portion 340 rests a wedge 332. Preferably, the wedge 332 is shaped and sized to adapt the anchor 300 to a polarity of vehicle frames. Accordingly, in one embodiment, the wedge 332 as an angle of incline equal to the angle of incline of the inclined plane portion 340, and is sized so that as the wedge 332 extends beyond the incline plane portion 340, the highest point of the wedge 332 (preferably the entire top plane of the wedge 332) is higher than the top of the flange 330. The wedge 332 travels across the incline plane portion 340 based on the positioning of a wedge bolt 350.

The wedge bolt 350 is preferably a threaded bolt which is reachable through the use of standard ratchet nuts through an opening in the platform-mounting portion 335 of the flange 330. Thus, as the wedge bolt 350 is “tightened” the wedge 332 travels “up” the incline plane 340 and secures the anchor 300 within a vehicle frame. Rigidly coupled to the flange 330 is a slide rail 334. The slide rail 334 typically comprises two pieces, each having a lip 333 that is adapted to coupled to the mounting plate 150. Preferably, as illustrated in FIG. 3, the slide rails 334 do in fact slide on the mounting plate as discussed below. The positioning of the mounting plate 150 relative to the slide rail 134 is fixed via the peg lock 170 (also as described below).

The anchor 300, the mounting plate 150, and the ball mount platform 140, together comprise a frame-mounting portion.

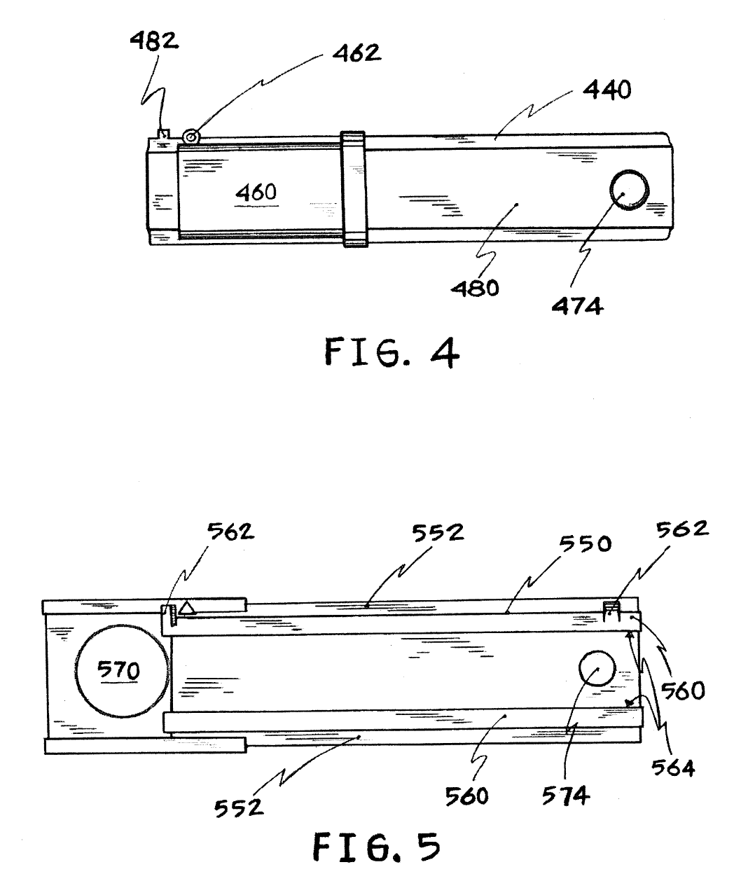

The ball mount 200 couples to the frame-mounting portion through a ball mount platform 400. To better understand the ball mount platform 400, FIG. 4 shows the ball mount platform 400 that is adapted for use with the ball mount storage device 100 of FIG. 1. The ball mount platform 400 generally includes a ball mount platform plate 480 and a ball mount receptacle 460 coupled there too.

Preferably, the ball mount receptacle 460 is coupled to the ball mount platform plate 480 via a pedestal (not shown in FIG. 4). The ball mount receptacle 460 is also preferably generally shaped like a vehicle frame, and is open at an end having a lip 466, and may be either open or closed at the opposite end. A swivel pin 462 is rigidly attached to the ball receptacle mount 460 so that an arm (not shown in FIG. 4) may move between a first position and a second position. In the first position, a cylinder of the arm is aligned with a ball mount platform lock hole 474, while in the second position the cylinder does not obstruct removal or placement of the ball mount 200.

The ball mount platform plate 480 is a generally plainer surface, and is preferably made of a metal. The ball mount platform plate 480 is preferably machined so as to have a ball mount platform track 440 running along either side of the ball mount receptacle 460. Each ball mount platform track 440 is capable of slidably coupling the ball mount platform plate 480 to amounting plate as discussed below. To further secure the ball mount platform plate 480 to the mounting plate, the ball mount platform plate 480 also maintains at least two platform braces 482 which extend along and above some portion of ball mount track. In operation, the ball mount platform track 440 slides within notches of the mounting plate, while the ball mount platform braces 482 extend above those notches which is apparent from the following discussion. The ball mount platform lock hole 474 aligns with a peg lock hole 174 as shown in FIG. 1.

FIG. 5 illustrates a mounting plate 500 that is adapted to couple the ball mount platform plate 480 to the anchor 300. Thus, FIG. 5 illustrates a mounting plate 500 for use with the ball mount storage device 100 of FIG. 1. The mounting plate 500 is a generally rectangular metallic plate sized to have a width and thickness to enable the mounting plate to couple to the slide rails 333. The mounting plate 500 maintains a mounting hole 570 which, when aligned with the wedge bolt 350, allows a user access to the wedge 350 with a standard socket so that the wedge bolt 350 may be tightened or loosened as needed.

Likewise, the mounting plate 500 has a padlock hole 574 which aligns with the ball mount platform lock hole 474 and allows a peg lock 170 to fit there through so as to secure the mounting plate 500 to the ball mount platform 480. The mounting plate 500 further comprises a first rail 560 and a second rail 561. Both the first rail 560 and the second rail 561 are adapted with rail stops 562 which extend to the edge of the mounting plate 500. Similarly, both the first rail 560 and the second rail 561 have a notch 566 running lengthwise along the portion of the first rail 560 and the second rail 561 which rests upon the mounting plate 500. Each notch 566 has a high thinner width and otherwise adapted to accept ball mount platform tracks. To facilitate the placement of ball mount platform tracks 440 within the notches 566, the first rail 560 and the second rail 561 have notch openings 564 located at the end of the mounting plate 500 opposite of the rail stops 562. The first rail 560 is rigidly coupled to the mounting plate 550 so as to provide a portion of the mounting plate 500 as a first track 552, the first track 552 being slidable into a first slide rail 333. Similarly, the second rail 561 is rigidly coupled to the mounting plate 500 so as to provide a portion of the mounting plate 500 as a second track that is slidable into the other slide rail 333.

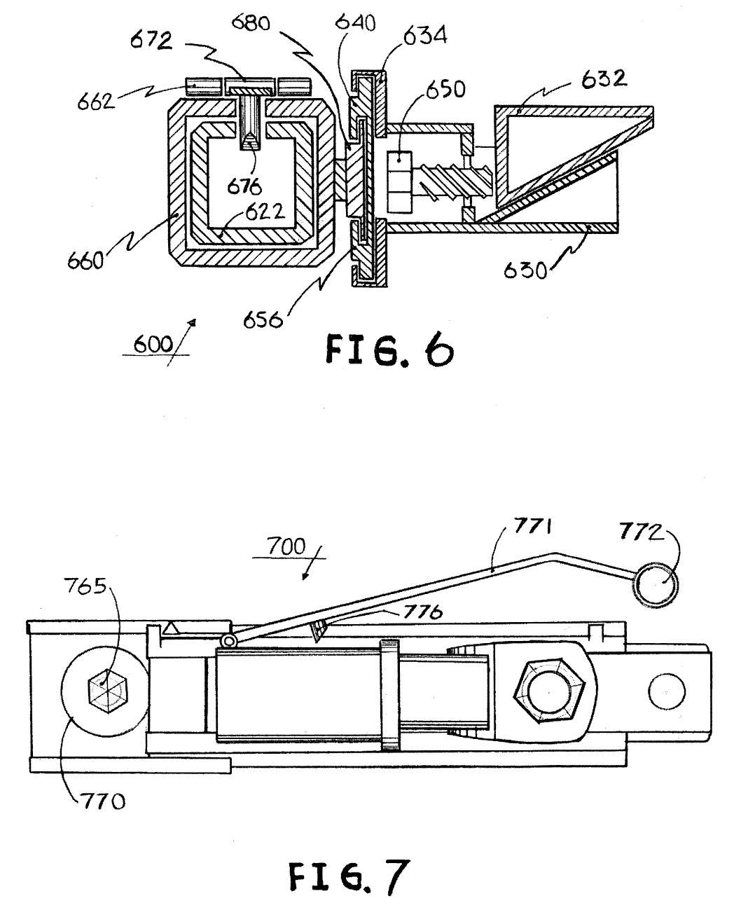

Additional features and benefits of the invention are discernable by examining FIG. 6, which is a cut view of the device 100 of FIG. 1, the cut taken along cut line A-A of FIG. 1. From FIG. 6, one can see the wedge 332 sitting upon the incline frame portion 340 of the flange 330, and supported in that position by the wedge bolt 350. Slide rails 334 are shown securing the mounting plate 550 with lips 333. Similarly, the first rail 560 and the second rail 561 are shown securing the ball mount platform 400 therein.

Also visible from FIG. 6 is the mount base 222 within the ball mount receptacle 460. The mounting pin 462 is also illustrated coupled to the ball mount receptacle 460. Coupled to the swivel pin 462 is the arm 171, and from this view of the device 100, one can see the anchor pin 676 which is coupled to the arm 171 as protruding through both the mount base hole 260 and the anchor hole 461 of the ball mount receptacle 460. FIG. 7 shows the device 100 wherein the arm 771 is in the second position, and the anchor pin 776, which is attached to the arm 771, is visible.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A ball mount storage device adapted to removably attach to a vehicle frame, comprising:
a frame mounting portion adapted to removably attach to a vehicle frame, and having a ball mount receptacle.

2. The device of claim 1 further comprising a ball mount adapted to couple to the ball mount receptacle.

3. The device of claim 2 wherein the ball mount comprises a mount base having a ball affixed thereto.

4. The device of claim 2 wherein the ball mount comprises a mount base adapted to couple to a ball mount receptacle, and a mounting lip coupled between the mount base and a hitch ball.

5. The device of claim 4 wherein the ball mount further comprises a mount base hole adapted to receive a holding pin, and a hitch ball nut that is adapted to attach to a threaded portion of a hitch ball.

6. The device of claim 1 wherein the frame mounting portion comprises a mounting plate coupled between a ball mount platform plate and an anchor.

7. The device of claim 6 wherein the anchor comprises a flange having an inclined plane portion and a platform-mounting portion.

8. The device of claim 7 wherein the anchor further comprises a wedge that is positioned to travel the inclined plane when a wedge mover is positioned against the wedge.

9. The device of claim 8 wherein the wedge mover is a wedge bolt.

10. The device of claim 7 further comprising a slide rail coupled to the platform-mounting portion of the flange, the slide rail adapted to accept a ball-mount platform track.

11. The device of claim 4 wherein the ball mount further comprises a mount base hole adapted to receive a holding pin, and a hitch ball nut that is adapted to attach to a threaded portion of a hitch ball.

12. The device of claim 6 wherein the ball mount platform plate further comprises the ball mount receptacle coupled to the ball mount platform plate.

13. The device of claim 6 wherein the ball mount platform plate further comprises a ball mount receptacle platform coupled between the ball mount receptacle and the ball mount platform plate.

14. The device of claim 12 further comprising a swivel pin coupled to the ball mount receptacle, the swivel pin adapted to support a handle.

15. The device of claim 6 further comprising a ball mount platform coupled to the ball mount platform plate such that:
a first ball mount platform track is created by the area between a top boundary of the ball mount platform plate and a top boundary of the ball mount platform, and
a second ball mount platform track is created by the area between a bottom boundary of the ball mount platform plate and a bottom boundary of the ball mount platform.

16. The hitch of claim 6 further comprising a ball mount platform coupled to the ball mount platform plate, the ball mount platform having a first ball mount platform brace and a second ball mount platform brace.

17. The hitch of claim 6 further comprising a ball mount platform lock hole that traverses through the ball mount platform and the ball mount platform plate, and is adapted to accept a peg lock.

18. The hitch of claim 6 further comprising a mounting plate lock hole that traverses through the mounting plate, and is adapted to accept a peg lock.

19. The hitch of claim 6 wherein the mounting plate further comprises a first rail configured to provide a rail stop and a notch for accepting a ball mount platform track, and a second rail configured to provide a second rail stop and a second notch for accepting a ball mount platform track.

20. The hitch of claim 6 further comprising a mounting hole that traverses through the mounting plate, and is adapted to align with a wedge bolt.

21. The hitch of claim 19 wherein the first rail is adapted to provide a portion of the mounting plate as a first track that is slidable into a first slide-rail.
